(19) United States
(12) Patent Application Publication
(10) Pub. No.: US 2013/0265689 A1
(43) Pub. Date: Oct. 10, 2013

(54) METHOD AND DEVICE FOR NEUTRALIZING AEROSOL PARTICLES

(71) Applicant: GIP MESSINSTRUMENTE GMBH, (US)

(72) Inventors: GERHARD KASPER, KARLSRUHE (DE); MARKUS WILD, KARLSRUHE (DE); MATTHIAS RICHTER, BITTERFELD-WOLFEN (DE)

(73) Assignee: GIP MESSINSTRUMENTE GMBH, MULDESTAUSEE (DE)

(21) Appl. No.: 13/658,443

(22) Filed: Oct. 23, 2012

Related U.S. Application Data
(63) Continuation-in-part of application No. 12/781,359, filed on May 17, 2010, now abandoned.

(30) Foreign Application Priority Data
May 16, 2009 (DE) 10 2009 021 631.6

(51) Int. Cl. H01T 23/00

(52) U.S. Cl. CPC H01T 23/00
USPC 361/231

(57) ABSTRACT

A method for the neutralization of aerosol particles uses a bipolar ion atmosphere generated by a dielectric barrier discharge to achieve a symmetric charge distribution on the particles. The aerosol-laden sample air passes, with a defined velocity, through the central flow channel of a first electrode, an adjoining discharge chamber and a downstream equilibration chamber. The wall electrode and the discharge chamber are surrounded by a plasma-resistant dielectric. The dielectric is at least in the region of the discharge chamber surrounded by a ring-shaped excitation electrode. A pulsating high voltage applied to the excitation electrode causes a dielectric barrier discharge between wall electrode and dielectric in the largely field-free discharge chamber, which generates positive and negative ions. A rod-shaped control electrode generates a weak electric field. The adjustable potential of the control electrode enables a controlled shift of the plasma-generated ion atmosphere to more positive or more negative charges.

### CROSS-REFERENCE TO RELATED APPLICATION

This is a continuation-in-part application of U.S. patent application Ser. No. 12/781,359, filed May 17, 2010; the application also claims the priority, under 35 U.S.C. §119, of German patent application No. DE 10 2009 021 631.6, filed May 16, 2009; the prior applications are herewith incorporated by reference in their entireties.

### BACKGROUND OF THE INVENTION

### Field of the Invention

The invention relates to a method for neutralizing aerosol particles using a dielectric barrier discharge, and to a device suitable for carrying out the method (neutralizer).

Electric mobility spectrometry is a well-proven method for measuring concentration and size distribution of airborne particles. Particularly widespread devices are “Differential Mobility Particle Sizers” (DMPS) and “Scanning Mobility Particle Sizers” (SMPS). Both devices contain a “Differential Mobility Analyser” (DMA), and a downstream particles detector, typically a condensation particle counter or an aerosol electrometer. The DMA classifies particles according to their electric mobility, i.e. only particles in a certain mobility range pass through the DMA. This mobility range can be set with the electric field strength and thus with the voltage applied to the DMA. For particles with a known number of charges, the mobility range corresponds to a size range. Thus particles size distributions can be analyzed by stepwise (DMPS) or continuously (SMPS) changing the DMA voltage. The particle size distribution of the sample air, which flows into the DMA, is then calculated from the concentrations measured downstream of the DMA.

The electric mobility of airborne particles depends on their size and the number of elementary charges on the particles (charge number); hence the particle size can be inferred from the electric mobility only for a known charge number. To determine particle size it is preferable having mostly single charged particles and only a low portion of multiple charged particles. Furthermore, the calculation of the actual size distribution requires accurately known charging probabilities as a function of particle size and charge number.

These requirements are however generally not met by the particles to be analyzed, and particularly for freshly generated particles the charging probabilities are essentially unknown.

Hence, before entering the mobility analyzer, sample air flows through a device to neutralize aerosol particles, a so-called neutralizer. The neutralizer serves to establish an equilibrium charge distribution; after the particles have passed through the neutralizer they feature well-known theoretically calculated equilibrium charging probabilities (Fuchs-Wiedensohler or Boltzmann distribution). Such charge distributions are near to symmetric, i.e. they features positive and negative particles in similar proportions, and the proportion of multiple charged particles is low over for a wide range of the particle size.

For neutralization, a relatively balanced bipolar ionic atmosphere in sufficiently high generation needs to be generated, for example by ionizing β-rays emitted by a radioactive ⁸⁵Kr-source. The generated gas ions diffuse to the surface of the particles and deposit charges of both polarities onto them. After a sufficient residence time in the neutralizer, particles feature an equilibrium charge distribution established by a statistical process. The bipolar ion atmosphere can be generated also by electric discharge, corona discharge or dielectric barrier discharge. After neutralization the polydisperse aerosol particles enter the mobility spectrometer.

When radioactive substances are used as an ion source, the radioactive decay leads to the emission of energy quanta which produce a relatively balanced bipolar ionic atmosphere in the surrounding gas space by the ionization of neutral molecules. This type of neutralizing agent has a practical application in the field of particle measurement technology for example. However, the strict safety-related regulations relating to handling radioactive material present a disadvantage here.

Because of the prescribed measures relating to radiation protection, the use is restricted to radioactive sources with very small intensities. Such devices have only a small neutralizing performance.

With neutralizing agents working on the basis of corona discharge, the use of two discharge systems with opposed polarities is necessary and their ion clouds must be produced and mixed in exactly the same ratio in order to produce a neutralizing effect. A complex control technique is necessary to do this. Moreover, the devices are sensitive to changes in the particle loading and the composition of the gas phase and are therefore susceptible to faults.

There is also a special form of corona-based neutralizing agents which manages with just one discharge system, triggering discharges of alternating polarities using an AC voltage. The method and a device for charging and charge reversing aerosols in a defined charge state of a bipolar diffusion charging using an electrical discharge in the aerosol space is described in published, non-prosecuted German patent application DE 103 48 217 A1, corresponding to U.S. Pat. No. 7,031,133.

A method is also known from German patent DE 10 2007 042 436 B3 for charging, charge reversing or discharging ions, especially for charging and charge reversing aerosol particles. The ions are produced outside a neutralization region in an ion production region. The ions are transported convectively to the neutralization region by an oscillating flow.

A major disadvantage of corona-based systems is that high electrical field strengths are required for maintaining the gas discharge which can lead to an undesired precipitation of the particles to be neutralized. This disadvantage can be overcome by a spatial separation of the ion production from the charging volume, though a large part of the ions are lost before their entry into the particle charging region by recombination or by losses through the walls. Accordingly, more ions and thus more ozone must be produced than is required for neutralization, or the performance of the neutralizing agent is correspondingly reduced. Furthermore, a flushing gas flow is required for transporting the ions from the corona zone into the charging space which leads to an unwanted dilution of the aerosol.

U.S. Pat. No. 4,472,756 describes a device for neutralization of charged materials using a corona electrode. The device consists of a cylindrical duct section in which a cylindrical plasma ion source is inserted. The ion source consists of a cylindrical dielectric, made of glass or ceramics, wire-shaped corona electrodes fixed at the inner surface of the dielectric, and an excitation electrode formed by a conductive coating, attached to the other side of the dielectric. When the excitation electrode is connected to an AC source, a plasma is formed at the whole inner surface of the dielectric. The charged materials are neutralized by ions of opposite polarity from the plasma. Apart from the general disadvantages of a corona discharge, this solution enables no control of the generated charge distribution on the neutralized material. Well defined, nearly symmetric, and stable charging probabilities as required by the electric mobility spectrometry cannot be established.

### SUMMARY OF THE INVENTION

It is accordingly an object of the invention to provide a method for neutralizing aerosol particles using a dielectric barrier discharge, which is economical to operate, which avoids the disadvantages of known methods, and which produces a symmetric bipolar ionic atmosphere at working conditions to provide particles with an equilibrium charge distribution.

The invention further contains a device to accomplish the method (i.e. a neutralizer).

According to the proposed method, aerosol-laden sample air flows with a defined velocity through a central flow channel formed by a first assembly of electrodes, at least one tubular grounded wall electrode, an adjoining discharge volume (discharge chamber), and a downstream equilibration volume (equilibration chamber). The wall electrode and the discharge vessel are enclosed by a plasma-resistant dielectric medium, which is, at least in the region of the discharge chamber, surrounded by a second assembly of electrodes, an annular excitation electrode. High voltage pulses applied to the excitation electrode causes a dielectric barrier discharge in the discharge volume, which is free from string electric fields, and generates simultaneously positive and negative ions. At the same time a weak radial electric field is generated during the discharge by a rod-shaped control electrode, which is supplied with constant voltage. The weak electric field is necessary in order to shift the ion atmosphere towards more positive or more negative polarity by adjusting the voltage of the control electrode. A stable charge distribution on the particles is established when ions and particles flow through the downstream equilibration chamber. The equilibration chamber is essential and its length is chosen in a way that the residence time of the particles is sufficient for achieving a stable charge equilibrium. The proposed method serves to generate a neutralized aerosol flow for accurate measurements of particle size distributions using a downstream electric mobility analyzer. A high voltage pulse generator is used for voltage supply of the excitation electrode. The pulses for generating and sustaining the plasma can be of arbitrary shape and saw-tooth, sinusoidal, rectangular, or needle-shaped pulses are basically suitable. The pulse sequence can be regular or random. It is however a requirement that number and intensity of pulses are sufficiently high for continuously supplying ions to the airflow. The pulse frequency is e.g. between 100 and 5,000 Hz, and the voltage e.g. between 2,000 and 10,000 V. To ensure continuous sufficient supply of ions to the airflow, pulse frequency can also be adapted to the flow rate. The excitation electrode is preferably supplied with sinusoidal high voltage of 20 kHz. The neutralization performance can be adjusted with the parameters of an operating voltage and a frequency.

It is essential for the existence of a bipolar ion atmosphere in the central flow channel and it is essential that the central flow channel is largely free from radial electric fields. According to the laws of electrostatic, this can be achieved by surrounding the central flow channel with conducting surfaces (the wall electrodes). Simulations of the electric field have shown that the radial component is indeed very weak in the region of the electrodes. The proposed method is suitable for neutralization of all kind of particles, particularly also for liquid droplets with a size down to the nanometer size range.

The proposed neutralizer contains of at least one first assembly of electrodes, a tubular grounded wall electrode with a central flow channel and an adjoining discharge chamber. The so called first assembly of electrodes can also be formed by two wall electrodes in series with a discharge chamber in between. The embodiment featuring only one wall electrode has a tubular shielding adjoining to the discharge chamber. At least the wall electrode and the discharge chamber are enclosed by a tubular plasma-resistant dielectric. The so called second assembly of electrodes is an annular excitation electrode surrounding the dielectric.

The neutralizer contains furthermore a third assembly of electrodes, a rod-shaped control electrode positioned at the longitudinal central axis of the wall electrode, which extends at least to the outlet side of the discharge chamber. The neutralizer features also a tubular equilibration chamber downstream of the discharge chamber.

During working conditions, the excitation electrode is connected to a high voltage pulse generator. The region of the discharge chamber is nearly field-free to sustain an inherently bipolar ion atmosphere. The control electrode is connected to a DC voltage source to maintain an adjustable voltage between the control electrode and the grounded wall electrode. This voltage is constant at working conditions. The rod-shaped control electrode can be solid or hollow.

According to the preferred embodiment, the control electrode consists, for achieving a high stability, of two telescoped hollow needles with different diameters. The transition is located ahead of the excitation electrode. The excitation electrode is either a disc, which is plugged on the dielectric, or a coil.

The control electrode is fixed with one end at the insulated part at the inlet side of the casing, and it can extend over the full length of the central flow channel. For embodiments featuring two wall electrodes or one wall electrode and a tubular shielding, electrodes and shielding are inserted in the tubular dielectric. The dielectric should consist of plasma-resistant material, preferably ceramics. Each wall electrode is beveled at the end that faces the discharge chamber.

The equilibration volume and accordingly the equilibration volume are preferably formed by an aluminum cylinder. During working conditions, the outlet of this cylinder is connected to the electric mobility analyzer.

The inlet and outlet of the equilibration chamber are cone-shaped to avoid dead volumes.

The neutralizer can be directly mounted into the sample line, a dilution of the aerosol flow is not necessary. The generation of ions and the neutralization occurs thus within one region, i.e. in the discharge chamber, the central flow channel and the equilibration chamber.

The following values are examples for the key parameters:

Pressure: 100 mbar to 5 bar (for higher pressures it is difficult to sustain the discharge); the operating temperature depends mainly on the used dielectric (<200° C. for PTFE; for ceramics much higher); relative humidity: <90%; maximum particle concentration: 10⁸ cm⁻³ or higher (i.e. at least as high as for established neutralizers).

Compared to the established methods and devices for neutralizing aerosol particles, which employ ionizing radiation or corona discharge, the invention enables a safe handling and features a higher neutralizing capacity. Moreover, the device can be manufactured by simple measures. Laboratory experiments showed very good results of the neutralization.

Other features which are considered as characteristic for the invention are set forth in the appended claims.

Although the invention is illustrated and described herein as embodied in a method and a device for neutralizing aerosol particles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective, longitudinal sectional view of a first embodiment of a device according to the invention;

FIG. 2 is a diagrammatic, perspective, longitudinal sectional view of a second embodiment of the device according to the invention;

FIG. 3 is a graph showing a concentration of positive and negative particles as a function of a DMA voltage for dielectric barrier discharge with a control electrode; and

FIG. 4 is a graph showing the concentration of the positive and negative particles as a function of the DMA voltage for a dielectric barrier discharge without the control electrode.

### DETAILED DESCRIPTION OF THE INVENTION

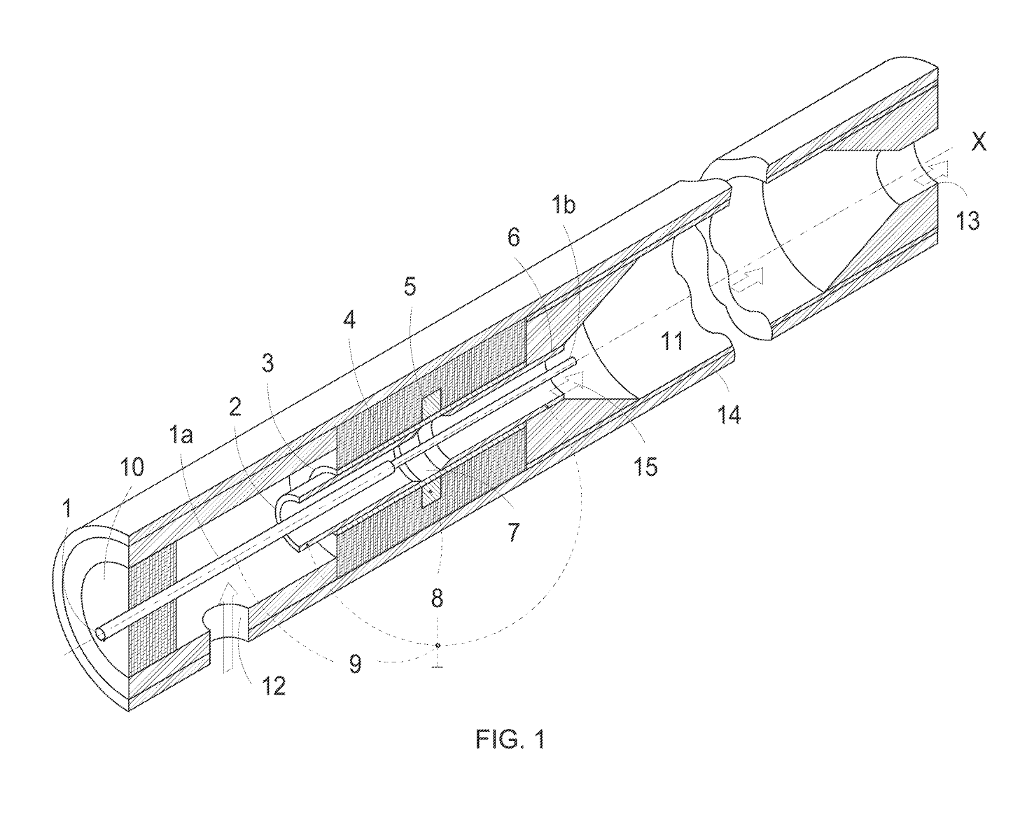

Referring now to the figures of the drawing in detail and first, particularly, to FIG. 1 thereof, there is shown a neutralizer formed of a tubular dielectric 3, an excitation electrode 5, connected to a high-voltage pulse generator 8, and two grounded wall electrodes, a first wall electrode 2 and a second wall electrode 6. The dashed line in FIG. 1 represents a connection of the excitation electrode 5 to the high-voltage pulse generator 8. The curved lines represent the grounding of the wall electrodes 2 and 6.

An insulated casing 14 encloses the components of the neutralizer. The first wall electrode 2 and the second wall electrode 6 are inserted in the tubular dielectric 3 at an inlet side and an outlet side, respectively, both stainless steel wall electrodes 3, 6 feature an inner diameter of 4 mm and are beveled on the side pointing to the excitation electrode.

A discharge chamber 7 is in a region between the two wall electrodes 2 and 6. The integral tubular dielectric 3 encloses the two wall electrodes 2 and 6. A ring-shaped disk serves as the excitation electrode 5 and encloses the tubular dielectric 3 in the region of the discharge chamber 7. The excitation electrode 5 is fitted to the dielectric 3. A coil can be an alternative embodiment of the excitation electrode 5. To avoid discharges, the joint fissure between the excitation electrode 5 and the dielectric 3 is filled with an epoxide resine.

The described embodiment features a horizontal distance between the first wall electrode 2 and the excitation electrode 5 of 0.4 mm (inlet side) and a horizontal distance between excitation electrode 5 and second wall electrode 6 of 0.9 mm (outlet side). The different distances determine the electric discharge to occur only between first wall electrode 2 (inlet side) and dielectric 3.

The wall electrodes 2, 6, through which the aerosol-laden sample air flows, and the excitation electrode 5 are coaxial. In the described embodiment, the dielectric 3 is formed from ceramics, e.g. Al₂O₃, and features a length of 20 mm, an inner diameter of 5 mm, and an outer diameter of 6 mm. The dielectric can be made of other suitable material, e.g. PTFE (Polytetrafluorethylen) or glass. The material should resist the exposure to the plasma.

The tubular wall electrodes 2, 6 form a central flow channel 15 for the aerosol. An insulator 4 encloses at least the dielectric 3.

A control electrode 1, formed by a thin rod, is located at a central axis X of the two wall electrodes 2 and 6. In the described embodiment, the control electrode consists, to improve stability, of two telescoped hollow needles 1a and 1b with different diameters, and the transition is ahead of the excitation electrode 5. The outer diameter of the first segment (inlet side) is 1.2 mm, and the outer diameter of the second segment (outlet side) is 0.6 mm.

The control electrode 1 is fastened with one end at an insulated disc 10 ahead of an aerosol inlet 12, and it extends at least to the second wall electrode 6.

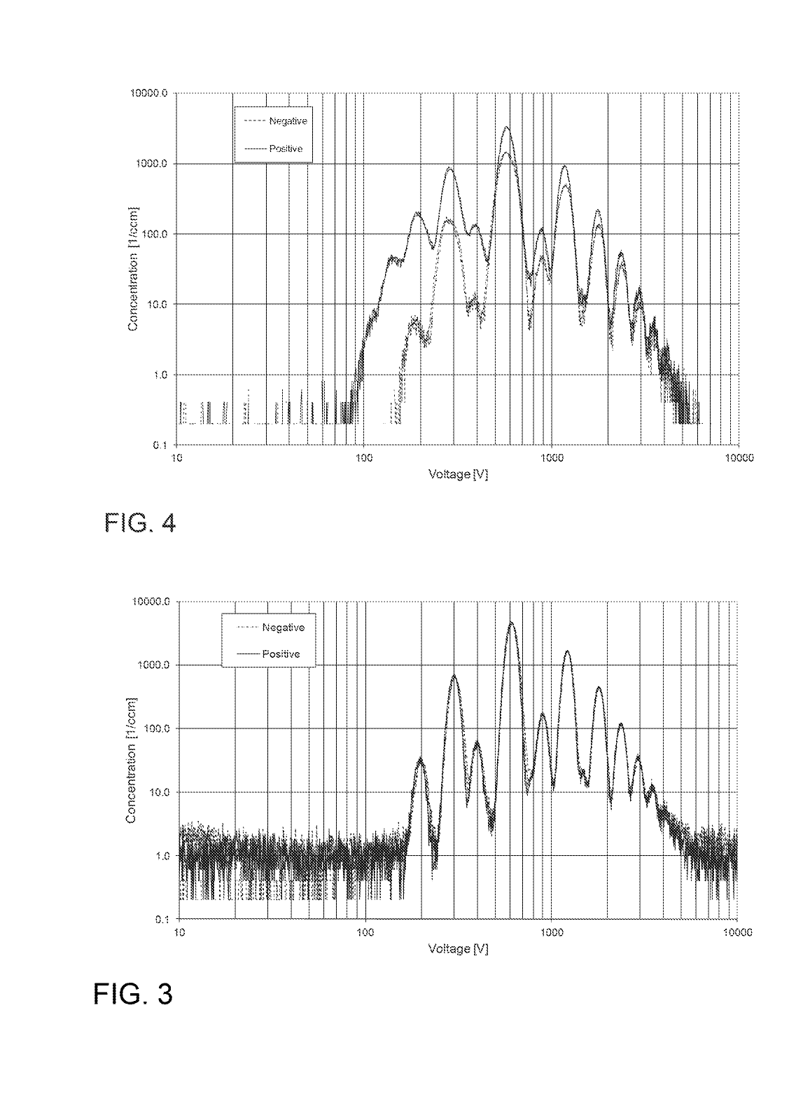

During working conditions, the control electrode 1 is supplied with a direct voltage of −0.5 V, the control voltage is held constant by an electronic circuit integrated in the device. The connection to the voltage supply is represented in FIG. 1 by a dashed line. The supplied voltage is defined by the requirement that any—for the operation without control voltage—non-symmetric charge distribution (FIG. 4) is converted to a symmetric one (FIG. 3). The value of the control voltage is determined experimentally and depends on the dimensions of the device.

The control electrode 1 serves to achieve nearly equal charging probabilities for positive and negative particles downstream of the neutralizer.

The described embodiment is configured for a flow rate of 0.3 lpm.

The device according to the invention contains also an equilibration chamber (volume) 11, located between an outlet of the second wall electrode 6 and a connector 13 to the inlet of the mobility spectrometer. The preferred embodiment of the equilibration chamber 11 is a tube section. The equilibration chamber 11 serves to assure a minimum residence time for the mixture of particles and ions, needed to achieve a stable charge distribution of the particles. The length of the equilibration chamber 11 is chosen to achieve that minimum residence time.

There are no specific demands on the material for the equilibration chamber 11.

The equilibration chamber 11 consists, e.g. for a flow rate of 0.3 lpm, of an aluminum tube featuring an inner diameter 19 mm and a length of 93 mm. Inlet and outlet are tapered to avoid dead volumes.

The neutralizer according to the invention works as follows.

The aerosol to be neutralized is guided to the inlet of the neutralizer. For the described embodiment, the inlet is at the lower side at the connector 12. The incoming aerosol flow is deflected by 90° and streams with a given velocity through the central flow channel 15, with the arrow indicating the flow direction. During working conditions, high voltage pulses are applied to the excitation electrode 5 and the dielectric barrier discharge between the dielectric 3 and at least one wall electrode 2 or 6 forms a plasma at the inner surface of the ceramic tube. In the described embodiment, the excitation electrode 5 is fed with a sinusoidal high voltage of 18 kHz and 5.6 KV (p/p). The plasma generates positive and negative ions simultaneously. The discharge volume is largely free from radial electric fields to enable a bipolar ion atmosphere to exist.

During operation conditions, the control electrode 1 is supplied with a constant voltage of −0.5 V. The control electrode 1 causes a weak radial field and thus controlled losses of ions. As the losses are different for positive and negative ions, the voltage of the control electrode 1 can be used to shift the ion atmosphere towards more positive or more negative ions in a controlled way. During the residence time in the downstream equilibration chamber 11, the particles achieve a stable equilibrium charge distribution; these properly neutralized particles are then guided to the subsequent mobility spectrometer.

The excitation electrode can be supplied with high voltage pulses of different shape, provided that amplitude and edge steepness are sufficient. In case of need the neutralization capacity can be adjusted by varying the parameters operating voltage and frequency.

The operating parameters to be applied to the neutralizer depend among other things on the geometry of the electrodes.

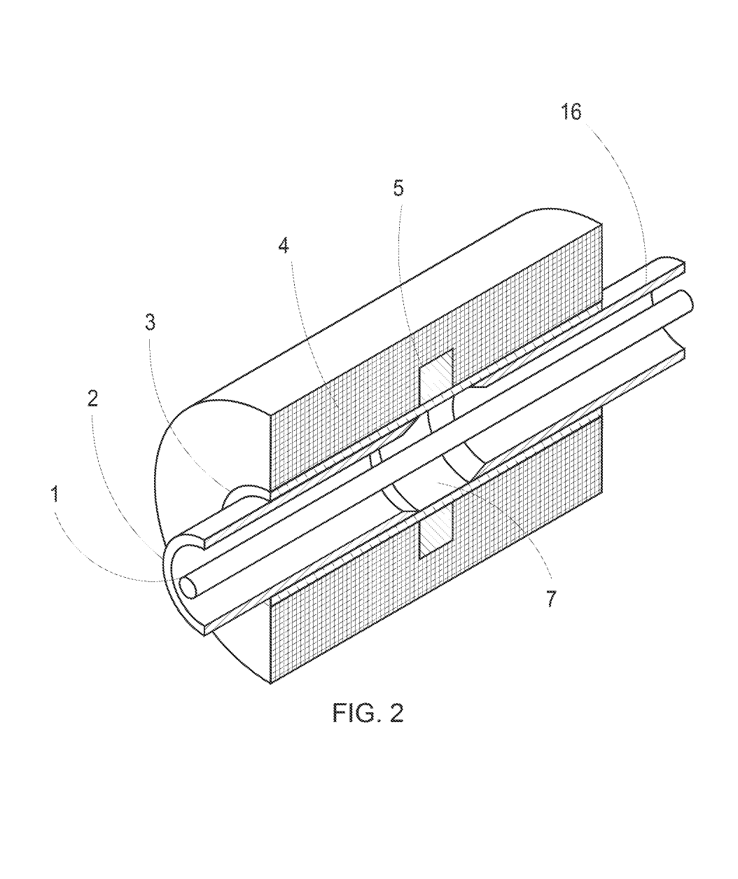

FIG. 2 shows the central section of the neutralizer in a second embodiment. The difference to the first embodiment shown in FIG. 1 is that the second embodiment features only one wall electrode 2 and a tubular shielding 16 is attached to the outlet side of the discharge chamber 7.

The functionality is the same as for neutralizer shown in FIG. 1.

1. A method for neutralization of aerosol particles using a bipolar ion atmosphere generated by a dielectric barrier discharge, which comprises the steps of:
passing an aerosol sample flow with a defined velocity through a central flow channel of a first electrode assembly having at least one tubular grounded wall electrode, an adjoining discharge chamber, and a downstream equilibration chamber, the tubular grounded wall electrode and the discharge chamber being enclosed by a plasma-resistant dielectric, the plasma-resistant dielectric being at least in a region of the discharge chamber surrounded by a second electrode assembly having an excitation electrode;
applying a pulsating high voltage to the excitation electrode for generating a dielectric barrier discharge between the tubular grounded wall electrode and the plasma-resistant dielectric in the largely field-free discharge chamber, thus generating positive and negative ions simultaneously, and featuring a third electrode assembly having a rod-shaped control electrode, centrically disposed in the central flow channel; and
supplying the rod-shaped control electrode with a constant DC voltage to generate a weak radial electric field, from an adjustable DC voltage source enabling a controlled shift of an ion atmosphere towards more positive or more negative charges, and the aerosol sample flow containing ions and particles passing through a downstream equilibration chamber to establish a stable equilibrium charge distribution on the particles.

2. The method according to claim 1, wherein with the aerosol sample flow passing through the central flow channel of a first tubular grounded wall electrode, the adjoining discharge chamber, and subsequently through a flow channel of a second tubular grounded wall electrode and through the downstream equilibration chamber.

3. The method according to claim 1, wherein the aerosol sample flow passes through the central flow channel of a first wall electrode, the adjoining discharge chamber, and subsequently through a flow channel of a tubular shielding and through the downstream equilibration chamber.

4. The method according to claim 1, which further comprises applying voltage pulses selected from the group consisting of triangular pulses, sine pulses, rectangular pulses and spike pulses to the excitation electrode, with a pulse sequence being periodic or random.

5. The method according to claim 4, which further comprises controlling a number of pulses in dependence on a flow rate, in a way that the sample air is continuously supplied with sufficient ions.

6. The method according to claim 1, wherein a constant change of polarity with a pulse sequence frequency of 100 up to 20 KHz takes place to maintain plasma.

7. The method according to claim 1, which further comprises adjusting a neutralization performance by varying parameters including an operating voltage and a frequency.

8. A device employing a dielectric barrier discharge for neutralization of aerosol particles, the device comprising:
at least one first electrode assembly having a tubular grounded wall electrode with a central flow channel and an adjoining discharge chamber;
a tubular dielectric surrounding said tubular grounded wall electrode and said discharge chamber;
a second electrode assembly having a ring-shaped excitation electrode surrounding said tubular dielectric;
a third electrode assembly having a rod-shaped control electrode positioned at a longitudinal central axis of said tubular grounded wall electrode, said rod-shaped control electrode extending at least up to an end of said discharge chamber in a direction of a flow;
an equilibration chamber disposed downstream of said excitation electrode;
a high-voltage pulse generator connected to said ring-shaped excitation electrode during working conditions, and a region of said discharge chamber being largely field-free to sustain an inherently bipolar character of an ion atmosphere generated by plasma; and
a DC source outputting an adjustable voltage, said control electrode connected to said DC source having the adjustable voltage with respect to said tubular grounded wall electrode, the adjustable voltage being constant during working conditions.

9. The device according to claim 8, wherein said control electrode has two telescoped stainless-steel hollow needles of different diameter with a transition region between said two telescoped stainless-steel hollow needles being disposed upstream of said excitation electrode.

10. The device according to claim 8, wherein said ring-shaped excitation electrode is a disc mounted on said tubular dielectric.

11. The device according to claim 8, wherein said tubular grounded wall electrode is one of two wall electrodes, inserted in each end of said tubular dielectric.

12. The device according to claim 11, wherein each of said wall electrodes is beveled at an inner side of an end facing said discharge chamber.

13. The device according to claim 9, wherein the said tubular dielectric is made from ceramics.

14. The device according to claim 8, wherein the said rod-shaped control electrode has an adjustable electric potential with reference to ground.

15. The device according to claim 8, wherein said rod-shaped control electrode extends over a total length of said central flow channel.

16. The device according to claim 8, further comprising a casing, said rod-shaped control electrode is fixed with one end at an insulated section of said casing.

17. The device according to claim 8, wherein said equilibration chamber is an aluminum cylinder.

18. The device according to claim 8, wherein said equilibration chamber has a cone-shaped inlet and a cone-shaped outlet.

19. The device according to claim 8, further comprising a tubular shielding, said discharge chamber is attached to said downstream tubular shielding.

20. The device according to claim 8, wherein said ring-shaped excitation electrode is a coil.
